(19) United States
(12) Patent Application Publication
(10) Pub. No.: US 2014/0231582 A1
(43) Pub. Date: Aug. 21, 2014

(54) Methods and Systems of Constructing a Multi Rotor Aircraft Fuselage

(71) Applicant: Sean Headrick, San Jose, CA (US)

(72) Inventor: Sean Headrick, San Jose, CA (US)

(21) Appl. No.: 14/045,646

(22) Filed: Oct. 3, 2013

Related U.S. Application Data
(60) Provisional application No. 61/709,269, filed on Oct. 3, 2012.

(51) Int. Cl. B64C 27/08; B64D 27/00; B64C 1/00

(52) U.S. Cl. CPC B64C 27/08; B64C 1/00; B64D 27/00
USPC 244/54

(57) ABSTRACT

A lower hull 403 and an upper hull 402 may form a multi rotor aircraft fuselage system comprising a comprising a thermoformed thin shell monocoque fuselage 500, center console assembly 200, the center console assembly comprising a center console cover 210, an auto pilot housing cover 220 and an auto pilot housing 225. A center fuselage area 300 contains the center console assembly 200. The center fuselage area is part of a plurality of arm assemblies 400. Each arm assembly may comprise a distal end 440 and a proximal end 410, an access panel cover 420 which may expose a access panel opening 419. An access panel opening 419 may lead to an arm void area 430, with the arm void area 430 further defined by the interior sections of the thin shell fuselage 500.

### CROSS-REFERENCE TO RELATED APPLICATIONS

This is a utility application based upon U.S. patent application Ser. No. 61/709,269 filed on Oct. 3, 2012. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to aviation. More particularly, the invention relates to means and methods of constructing and using a thin shell design to both house and protect mechanical components.

(2) Description of the Related Art

Other means of constructing a fuselage for a multi rotor air craft are known in the related art. In the known related art, a fuselage for a multi rotor air craft comprises the fastening (using bolts, nuts and other traditional methods) of fuselage plates, square and round tubing arms and various other components. A noted shortfall in the related art is that fuselage frames are relatively heavy and fragile and are in constant need of maintenance that includes tightening and alignment procedures.

In the related art, center plates are fabricated with aluminum or carbon fiber or other similar material. The related art center plates are stacked using metal or nylon fasteners and spacers. The center plate area is often used to contain or mount auto pilot systems and other electronics. In the event of crash, sudden change in speed or exposure to high external forces, the cumulative effect of many fastener locations can result in significant frame distortion. In prior art systems, some level of this distortion persists even after the force has subsided. In stark contrast, disclosed thin shell systems deform minimally under the same loads and no deformation remains after an external force is removed.

In the related art, square or round tubular arms are sandwiched between two of the center plates or are fastened to a single center plate with mounting brackets. The force applied to a prior art center plate/arm joint is subjected to lever amplification as the ends of the arms (distal ends) house motors and the length of the arms act as levers. This means that any force applied to the end (distal end) of the motor mount arm is multiplied many times over resulting in damage or a failure to the fastener system holding the arm to the center section.

In the related art, motor mounts are attached to the end of the arms (or distal ends) and facilitate the fastening of a motor body. Aluminum is the most common material used for such applications. The prior art motor and mount systems are both vulnerable in the event of an in-flight failure. The prior art designs cause the motors strike the ground in the event of a crash landing or in in landing. Such ground to motor impacts result in damage to either the motor/mount assembly or individual components. The prior art assemblies are also quite heavy and require more rotational force to be applied to maintain flight attitude.

Thus, there is a long felt need in the art for the disclosed embodiments.

### BRIEF SUMMARY OF THE INVENTION

The present invention overcomes shortfalls in the related art by presenting an unobvious and unique combination and configuration of methods and components to enclose aircraft components. Disclosed embodiments include a thin skin design or thin shell design wherein a thin shell structure encloses many components of an aircraft, protecting such components from water, dirt, other environmental hazards as well as damage from impact.

Disclosed embodiments include the use of the thermoformed or injected molded shells wherein a mold is used to create a single hollow shell. The molding process may include the construction of two half shells which, after construction and insertion of mechanical components, may be fastened together by various means, including the use of industrial elastomeric adhesive.

Disclosed embodiments include the use of new center console system to allow for efficient access autopilot systems and various other components. A new hard point mounting system facilitates ease of use and construction.

Disclosed embodiments include the use and construction of a GPS and aerometer mast.

Disclosed embodiments include new means and methods of thin shell construction which combine motors, electronic assemblies and other components into a single thermoformed polymer shell assembly. This type of construction allows for external forces to be dispersed over the entire “skin” or outer surface of the shell as opposed to concentrating those forces on a few small fasteners as found in the prior art. In the disclosed embodiments, fasteners are of similar material to the shell. The similarity of material assists in dissipating the load of external forces. In strong contrast, the prior art's use of dissimilar materials between fasteners and fuselage parts causes dangerous distortion in the weaker material.

Disclosed methods and systems will see even greater efficiencies as vehicles grows in scale. This gain in efficiency is seen as the opportunity for more payload (such as batteries) and longer sustained flight.

Disclosed methods of thermo forming or Injection molding also allows for rapid manufacturing with low cost raw materials while still obtaining increased performance.

Disclosed embodiments allow for the construction and use of user accessible panels facilitating the servicing of motor components, escape components, motor connections and other components. Multi-axis positioning of the fasteners located around escape panels and center hub reinforcement are threaded through the body and panel to maintain the integrity of the thin shell structure.

Disclosed thin shell structures are relatively light in weight and may be comprised of shell elements. Disclosed shell elements are typically curved or convex and are assembled into larger structures.

Typical applications of the disclosed embodiments include are fuselages of airplanes, boat hulls and roof structures in some buildings. A thin shell is defined as a shell with a thickness which is small compared to its other dimensions and in which deformations are not large compared to thickness. A primary difference between a shell structure and a plate structure is that, in the unstressed state, the shell structure has curvature as opposed to plate structures which are flat. Membrane action in a shell is primarily caused by in-plane forces (plane stress), though there may be secondary forces resulting from flexural deformations. Where a flat plate acts similar to a beam with bending and shear stresses, shells are analogous to a cable which resists loads through tensile stresses. Though the ideal thin shell is be capable of developing both tension and compression.

Embodiments of the present invention may be constructed via the following process:

Using polystyrene or similarly solvent welded material of thickness varying from 0.040″-0.125″ in thickness relative to overall frame dimensions. Two halves of the bodies may be vacuum formed over positive molds or into negative molds to create a curved skin that is then welded together using a suitable solvent welding cement creating a strong uni-body design.

Alternatively the two halves may be injection molded with glass fiber to allow for higher production and less post processing. This method may ultimately create a more accurate frame resulting in a better assembly and overall better performance.

The disclosed embodiments have many applications and the scope of this disclosure is not limited by the disclosed embodiments.

These and other objects and advantages will be made apparent when considering the following detailed specification when taken in conjunction with the drawings.

### BRIEF DESCRIPTION OF THE DRAWINGS

FIG. 1 depicts a perspective view of a partially assembled embodiment

FIG. 2 depicts a plan view of a distal end of an arm

FIG. 3 depicts an enlarged and exploded view of a center console assembly

FIG. 4 depicts a perspective view of a multi rotor vehicle

FIG. 5 depicts a perspective view of an assembled embodiment having a GPS and aerometer mast

FIG. 6 depicts a lower shell

FIG. 7 depicts a motor pod detail

FIG. 8 depicts two shell halves

FIG. 9 depicts an upper shell

### REFERENCE NUMERALS IN THE DRAWINGS

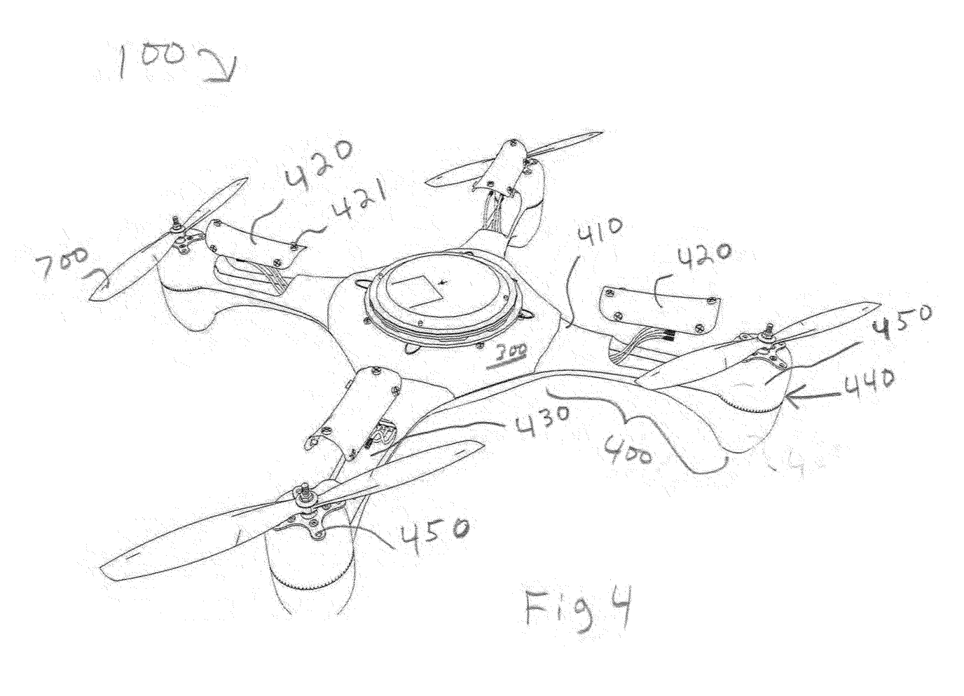

100 an embodiment of the invention in general shown in FIG. 4

200 a center console assembly

205 rubber fastening system of center console assembly

210 center console cover

215 arched outer perimeter of a center console cover 210

220 auto pilot housing cover

222 auto pilot access panel

225 auto pilot housing

230 mounting ring

232 mounting ring voids at perimeter of mounting ring 230

235 mounting stud of mounting ring 230

300 center fuselage area

310 hard point mounting system of a center fuselage area 300

315 arm/disarm plug

400 arm assembly

402 upper hull of arm assembly

403 lower hull of arm assembly

410 proximal section of arm assembly 400, near center fuselage area 300

419 access panel opening

420 access panel cover of arm assembly 400

421 fastener of access panel cover 420 of arm assembly 400

430 arm void area defined by outer sections of arm assembly 400

440 distal end of arm assembly 400

450 motor housing of distal end 440 of arm assembly 400

470 motor bulkhead reinforcement

480 landing contact section of distal end of lower hull

500 thin shell monocoque fuselage

600 GPS aerometer mast

604 rubber ring fastening system of aerometer mast

700 propeller

800 lower shell

850 upper shell

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

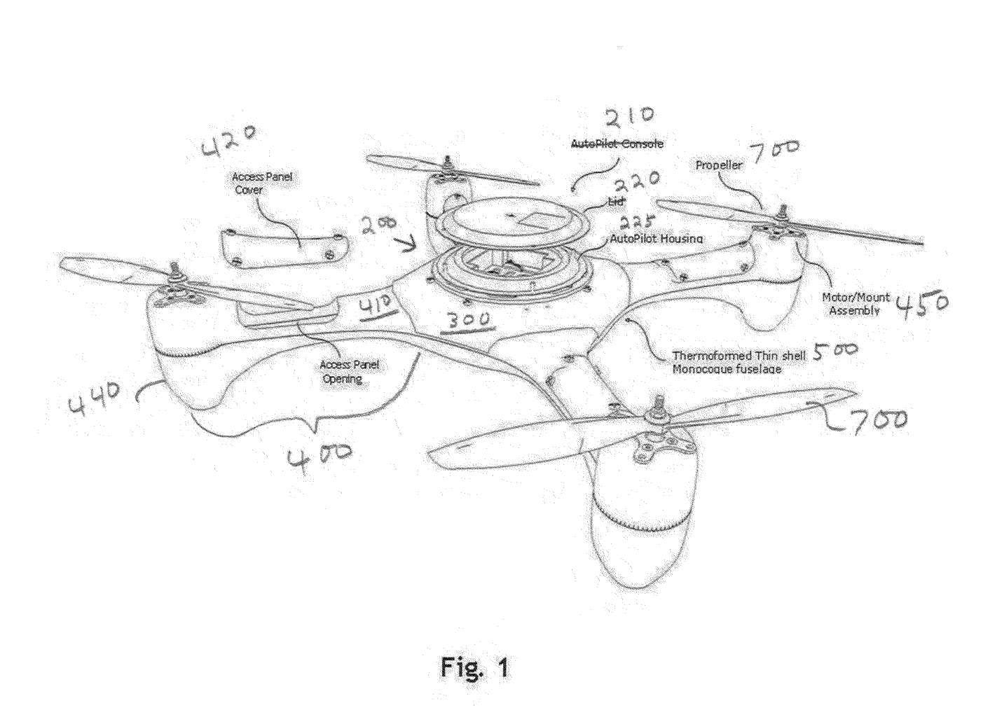

FIG. 1 depicts a perspective view of a disclosed embodiment comprising a thermoformed thin shell monocoque fuselage 500, center console assembly 200, the center console assembly comprising a center console cover 210, an auto pilot housing cover 220 and an auto pilot housing 225.

A center fuselage area 300 contains the center console assembly 200. The center fuselage area is part of a plurality of arm assemblies 400. Each arm assembly may comprise a distal end 440 and a proximal end 410, an access panel cover 420 which may expose a access panel opening 419. An access panel opening 419 may lead to an arm void area 430, with the arm void area 430 further defined by the interior sections of the thin shell fuselage 500.

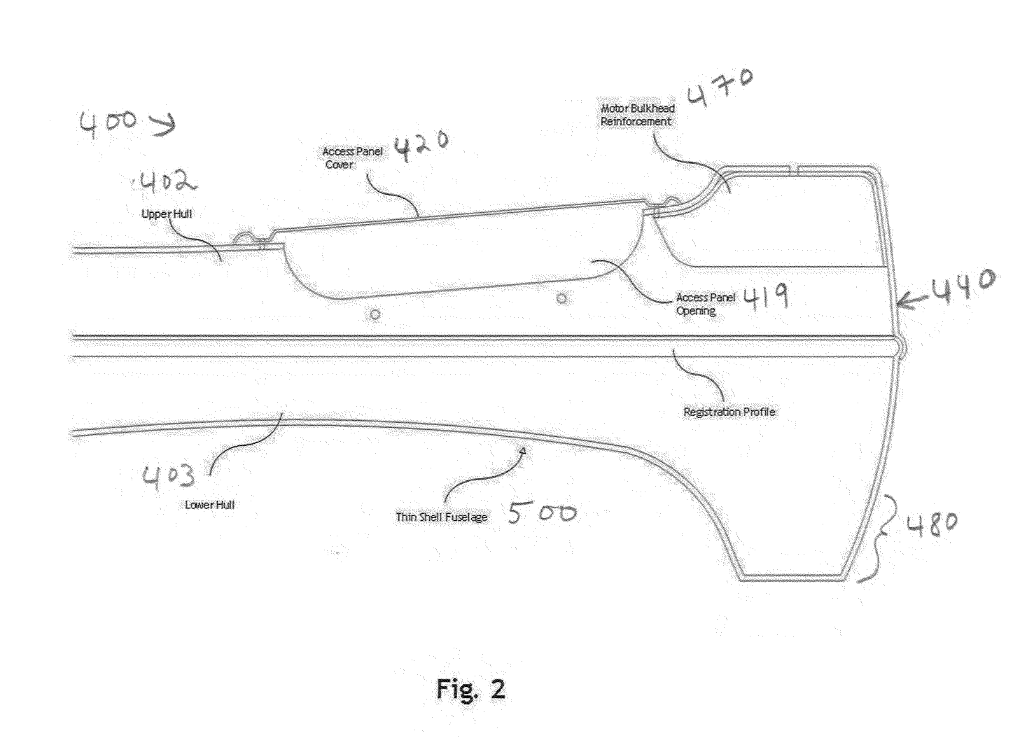

FIG. 2 depicts an enlarged elevation view of an arm assembly 400 comprising an upper hull 403, a lower hull 403, an access panel cover 420, exposing access panel opening 419; motor bulkhead reinforcement 470 and a landing contact section 480.

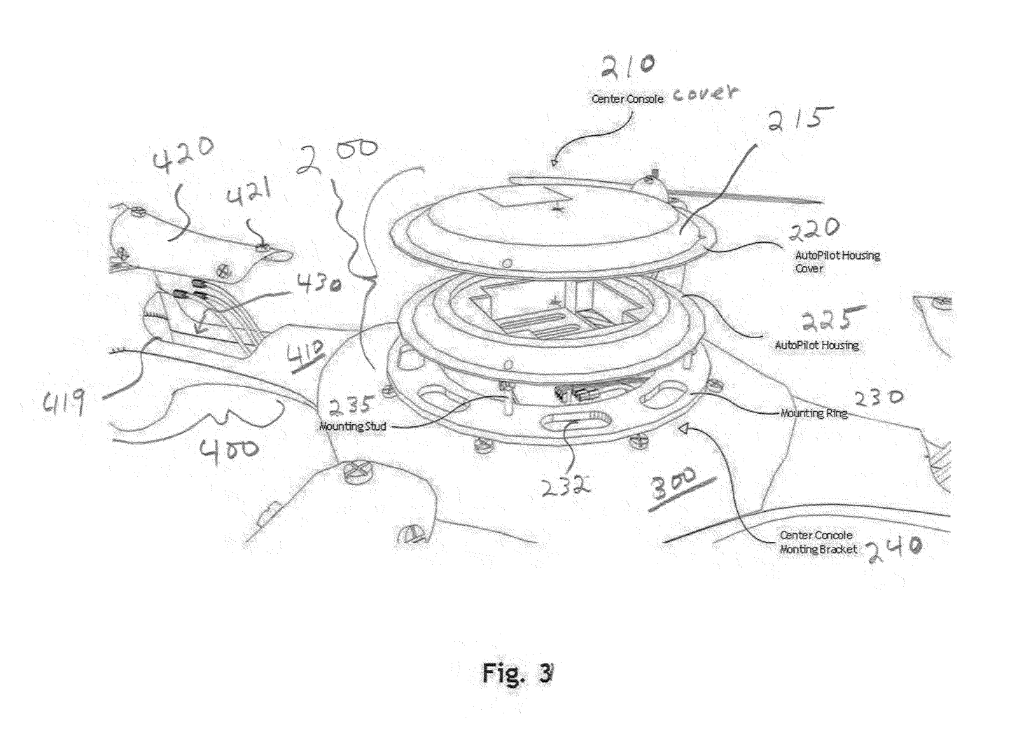

FIG. 3 depicts an enlarged are partially exploded view of center console assemble 200 comprising a center console cover 210, the center console cover 210 having an arched outer perimeter 215. A console assemble may also comprise an auto pilot housing cover 220, an auto pilot housing 225 and a mounting ring 230, with the mounting ring sometimes comprising a plurality of mounting ring voids 232. A mounting ring may also comprise a plurality of mounting studs 235. The console assembly 200 may also comprise a center console mounting bracket 240. The console assembly 200 may be contained within a center fuselage area 300. Partial views of arm assemblies 400 are shown with the arm assemblies comprising a proximal end 410 near or adjacent to the center fuselage area 300.

An arm assembly 400 may comprise an access panel cover 420, with the access panel cover comprising a plurality of fasteners 421. An arm assembly 400 may also comprise an access panel opening 419 which may lead to and partially define an arm void area 430.

FIG. 4 depicts a disclosed embodiment 100 in general having components similar to those in FIGS. 1 and 3. FIG. 4 does show a motor housing 450 at a distal end 450 of an arm assembly 400.

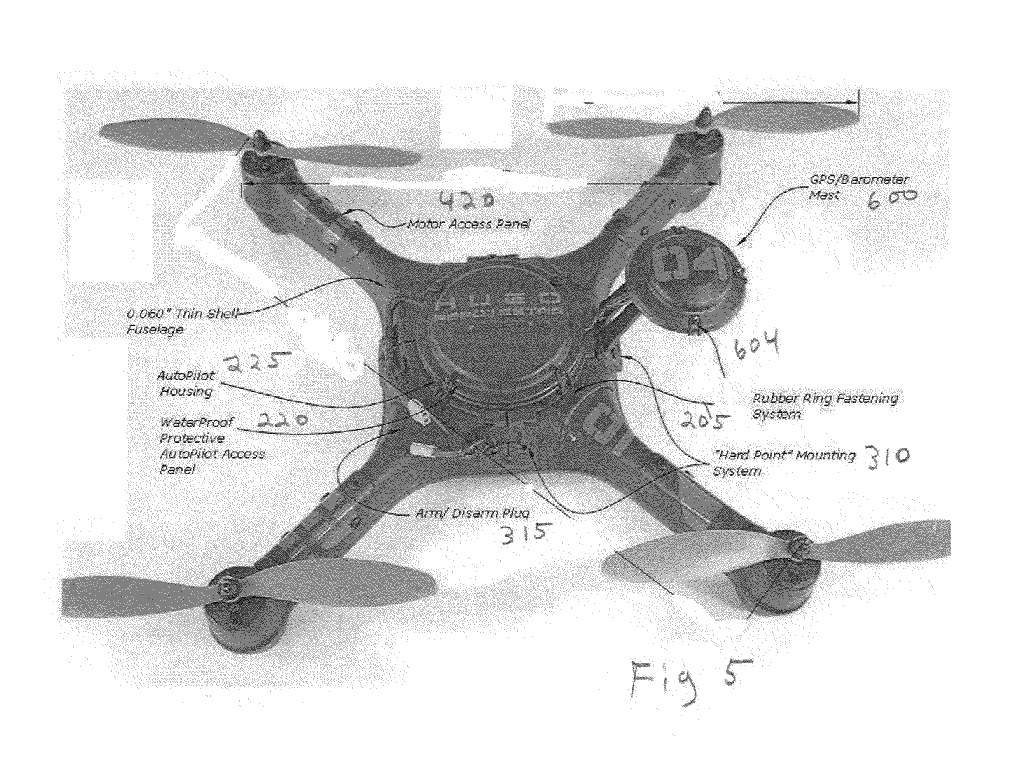

FIG. 5 depicts an alternative embodiment having waterproof protective autopilot access panel 220, an arm/disarm plug 315, a hard point mounting system 310; and a GPS/Aerometer mast 600 with a rubber fastening system 604. A rubber fastening system 205 is shown in attachment to a center console assembly.

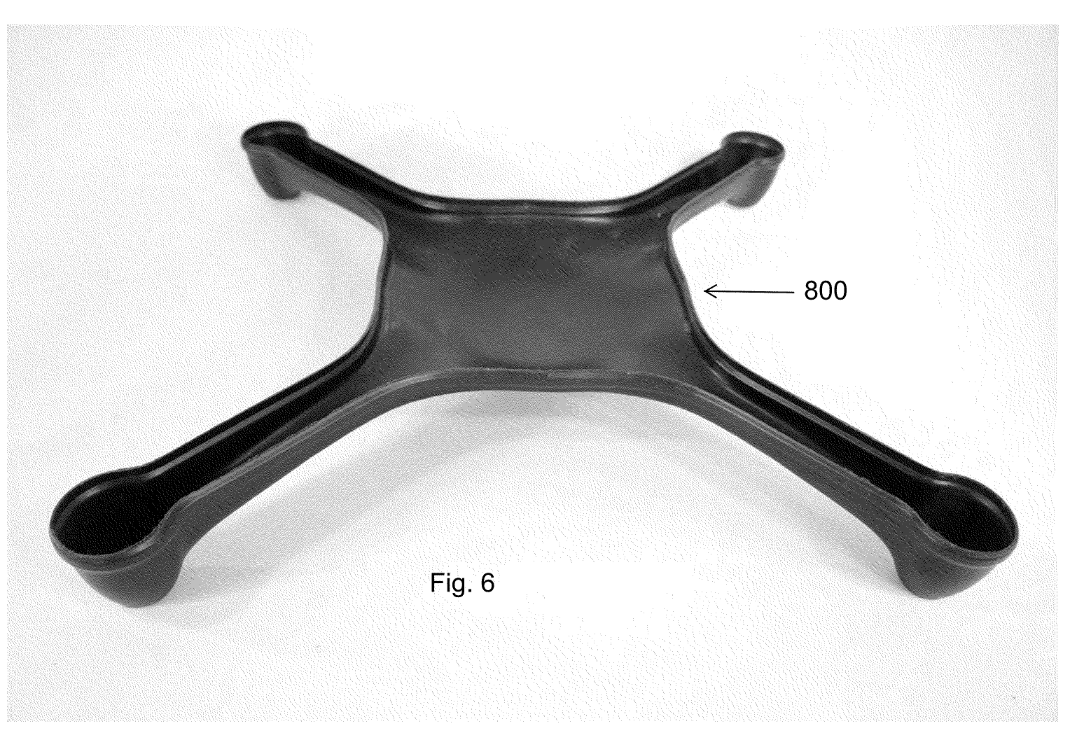

FIG. 6 depicts a lower shell 800 or lower shell assembly

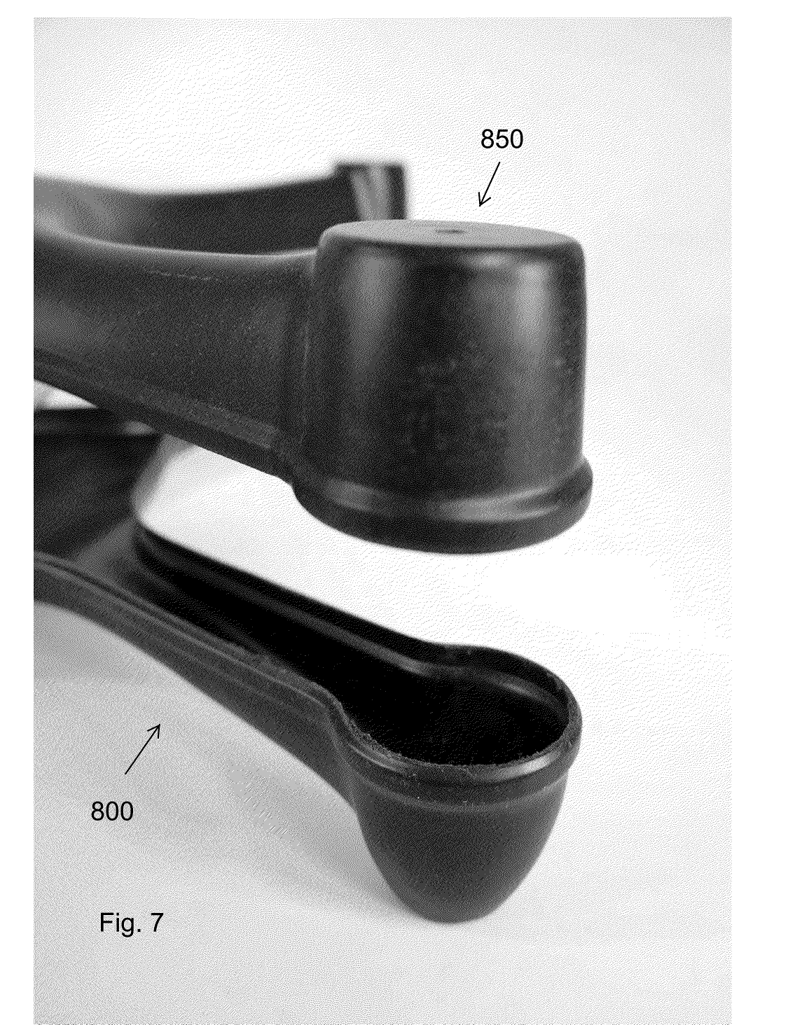

FIG. 7 depicts distal ends of an upper shell 850 and lower shell 800

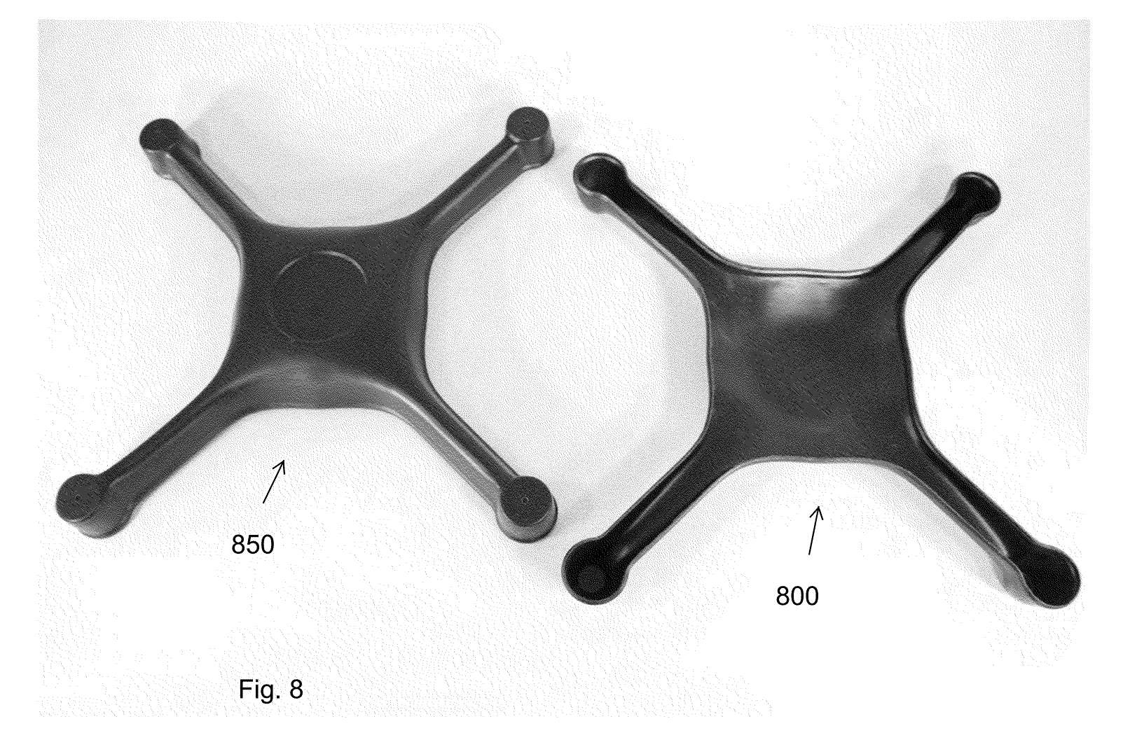

FIG. 8 depicts an upper shell 850 and lower shell 800.

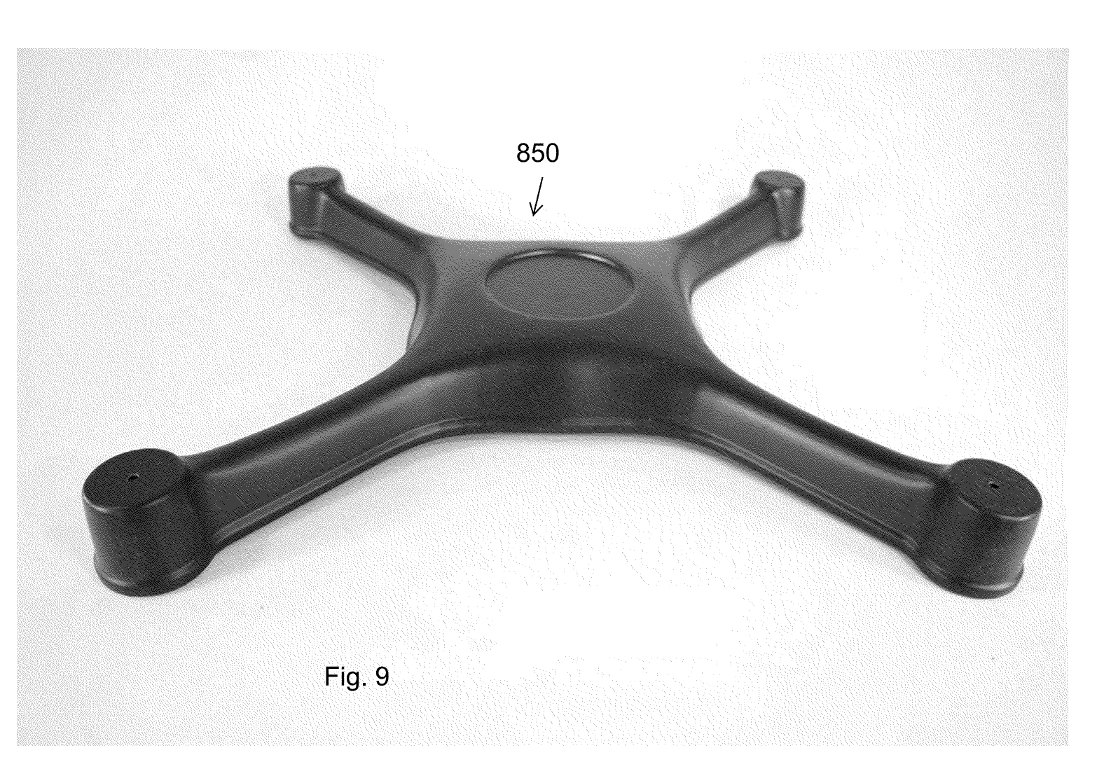

FIG. 9 depicts an upper shell 850

Items

Disclosed embodiments include but are not limited by the following items.

Item 1. A multi rotor aircraft fuselage 100 comprising:

a center console assembly 200, the center console assembly comprising a center console cover 210, an auto pilot access panel 222, an auto pilot housing, a mounting ring 230, and mounting ring studs 235;

a center fuselage area 300 containing the center console assembly and the center fuselage area attached to a plurality of arm assemblies 400 with the arm assemblies comprising a proximal end 410 a distal end 440, an access panel cover 420, an access panel opening 419, a motor mount assembly 450 at the distal end of the arm assembly and a landing contact section 480 at the distal end of the arm assembly; and

the center fuselage area and the arm assembly comprising a lower hull 403 attached to an upper hull 402 with a plurality of motors contained within the motor mount assembly.

Item 2. The multi rotor aircraft fuselage of item 1 further comprising a GPS and aerometer mast 600, the mast secured together with a rubber ring fastening system 604;

the center console assembly secured with a rubber ring fastening system 205; and

the center fuselage area comprising an arm/disarm plug 315.

Item 3. The multi rotor aircraft fuselage of item 2 further comprising an arm void area 430 defined by the outer sections of the arm assembly 400.

Item 4. The multi rotor aircraft fuselage of item 3 wherein the mounting ring comprises a plurality of mounting ring voids 232.

Item 5. The multi rotor aircraft fuselage of item 4 wherein the lower hull and upper hull are vacuum formed over positive molds.

Item 6. The multi rotor aircraft fuselage of item 5 wherein the lower hull and upper hull are attached by solvent welding cement.

What is claimed is:

1. A multi rotor aircraft fuselage comprising:
a center console assembly, the center console assembly comprising a center console cover, an auto pilot access panel, an auto pilot housing, a mounting ring, and mounting ring studs;
a center fuselage area containing the center console assembly and the center fuselage area attached to a plurality of arm assemblies with the arm assemblies comprising a proximal end, a distal end, an access panel cover, an access panel opening, a motor mount assembly at the distal end of the arm assembly and a landing contact section at the distal end of the arm assembly; and
the center fuselage area and the arm assembly comprising a lower hull attached to an upper hull with a plurality of motors contained within the motor mount assembly.

2. The multi rotor aircraft fuselage of claim 1 further comprising a GPS and aerometer mast, the mast secured together with a rubber ring fastening system; the center console assembly secured with a rubber ring fastening system; and the center fuselage area comprising an arm/disarm plug.

3. The multi rotor aircraft fuselage of claim 2 further comprising an arm void area defined by the outer sections of the arm assembly.

4. The multi rotor aircraft fuselage of claim 3 wherein the mounting ring comprises a plurality of mounting ring voids.

5. The multi rotor aircraft fuselage of claim 4 wherein the lower hull and upper hull are vacuum formed over positive molds.

6. The multi rotor aircraft fuselage of claim 5 wherein the lower hull and upper hull are attached by solvent welding cement.
